(19) United States
(12) Patent Application Publication
(10) Pub. No.: US 2011/0015992 A1
(43) Pub. Date: Jan. 20, 2011

(54) ESTIMATING STATISTICS FOR ONLINE ADVERTISING CAMPAIGNS

(76) Inventors: Mark Liffiton, Ann Arbor, MI (US); Nathalie Criou, San Francisco, CA (US); Ching Law, Mountain View, CA (US); Fong Shen, San Jose, CA (US)

Correspondence Address: FISH & RICHARDSON P.C., PO BOX 1022, MINNEAPOLIS, MN, 55440-1022, US

(21) Appl. No.: 12/067,238

(22) PCT Filed: Dec. 21, 2007
(86) PCT No.: PCT/US07/88654

§ 371 Date: Aug. 24, 2010

Related U.S. Application Data
(63) Continuation of application No. 11/614,762, filed on Dec. 21, 2006, now abandoned.

(51) Int. Cl. G06Q 30/00

(52) U.S. Cl. 705/14.46

(57) ABSTRACT

Methods and systems associated with online advertising campaigns are described. For example, systems and methods are described, which provide estimated advertising campaign statistics (e.g., in real-time) based on hypothetical online advertising campaign parameters entered by users. In certain implementations, the described systems combine pre-processed log data with real-time algorithms to estimate statistics for online advertising campaigns, which target a particular set of digital documents that display advertisements.

### CROSS-REFERENCE TO RELATED APPLICATIONS

This application claims priority to U.S. application Ser. No. 11/614,762, filed on Dec. 21, 2006, titled “Estimating Statistics for Online Advertising Campaigns”, the contents of which are here incorporated by reference.

### TECHNICAL FIELD

This instant specification relates to online advertising.

### BACKGROUND

As the Internet has increased in popularity, more and more businesses are interested in advertising their products or services to the growing audience of Internet users. In certain online advertising systems, a business can select websites on which to advertise along with one or more advertisements (“ads”) for display to the Internet users. The online advertising system then can display the one or more ads to the Internet users that visit the selected sites.

The business' selection of the websites and ads to use in future online advertising campaigns may be based on experience with traditional advertising (e.g., print ads, TV ads, etc.) or on personal experience with previous online advertising campaigns. However, personal experience may not provide a sufficient estimate of an online ad campaign's performance.

### SUMMARY

In general, methods and systems associated with online advertising campaigns are described. For example, systems and methods are described, which provide estimated advertising campaign statistics (e.g., in real-time) based on hypothetical online advertising campaign parameters entered by users. In certain implementations, the described systems combine pre-processed log data with real-time algorithms to estimate statistics for online advertising campaigns, which target a particular set of digital documents (e.g., websites) that display advertisements. For example, the statistics can include a hypothetical reach value (e.g., how many unique users are reached by an online ad campaign) and a hypothetical frequency value (e.g., an average of how many times a unique user is presented with an ad).

In certain implementations, a computer-implemented method is described. The method includes determining a first number of advertisement impressions per digital document visitor for a portion of a set of digital document visitors using log data. The method also includes outputting, in response to a potential advertiser inputting one or more parameters associated with a proposed online advertising campaign, an estimate of a second number of digital document visitors reached by the proposed online advertising campaign associated with the one or more parameters.

In other implementations, a system is described. The system includes a log analyzer for generating data specifying a number of advertisements displayed for combinations of digital documents and advertising campaign restrictions, an interface for receiving digital document and campaign restriction combination information from a potential advertiser, and a pre-campaign server for outputting an estimate of a number of unique visitors reached by a proposed online advertising campaign at least partially defined by the received digital document and campaign restriction combination information.

In certain implementations, the systems and methods described here may provide one or more of the following advantages. First, a number of unique visitors to a digital document can be determined without using cookies. Second, an estimate of reach and frequency campaign statistics can be created for online marketing campaigns. Third, substantially accurate campaign performance estimates can be provided despite a volatile audience of Internet users. Fourth, a potential advertiser can refine an advertising campaign's parameters based on historical performance of similar campaigns.

The details of one or more embodiments of an online ad campaign estimator are set forth in the accompanying drawings and the description below. Other features and advantages of the online ad campaign estimator will be apparent from the description and drawings, and from the claims.

### DESCRIPTION OF DRAWINGS

FIG. 1 schematically shows an exemplary system for generating information used by a system to provide estimations for the performance of a user input advertising campaign.

FIG. 2 is a schematic of an exemplary run-time query system used to generate a pre-campaign estimate for a user.

FIG. 3 is a detailed view of an example advertisement impression log.

FIG. 4A is a block diagram of an exemplary log analyzer.

FIG. 4B is an example set of impression/IP data.

FIG. 5 is an example user interface for a runtime query system for entering advertising campaign information used to generate pre-campaign estimations.

FIG. 6 is a flowchart of an example method for pre-campaign processing.

FIG. 7 is a flowchart of an example method for estimating reach and frequency of an ad campaign.

FIG. 8 is a flowchart of an example method for estimating total unique visitors.

FIG. 9 is a general computer system.

Like reference symbols in the various drawings indicate like elements.

### DETAILED DESCRIPTION

In certain implementations, systems and methods are described for providing estimated ad campaign statistics (e.g., in real-time) based on, for example, hypothetical online advertising campaign parameters entered by users. In certain implementations, the described systems combine pre-processed log data with real-time algorithms to estimate the statistics for online advertising campaigns targeting a particular set of digital documents (e.g., websites, portable document files (PDFs), emails, word processor files, spreadsheet files, digital images, etc.) that display advertisements (“ads”). Although, the following description uses websites or web pages as examples of digital documents, certain implementations can use other digital documents.

The statistics can include a hypothetical reach value (e.g., how many unique users are reached by an online ad campaign) and a hypothetical frequency value (e.g., an average of how many times a unique user is presented with an ad).

Additionally, a user can modify the advertising campaign parameters to see how the reach and frequency of the campaign are affected when different parameters are entered. For example, the user can enter a first set of advertising campaign parameters, which may include a set of digital documents on which to display ads, images associated with the ad, countries associated with the ads, etc. If the reach and frequency estimates generated based on the campaign parameters do not satisfy the user, he or she can enter different campaign parameters that are used to generate different estimates of reach and frequency. This process can continue, for instance, until the user is satisfied with the estimated frequency and reach for a set of entered campaign parameters. The systems and methods that provide the estimated statistics are described in more detail below.

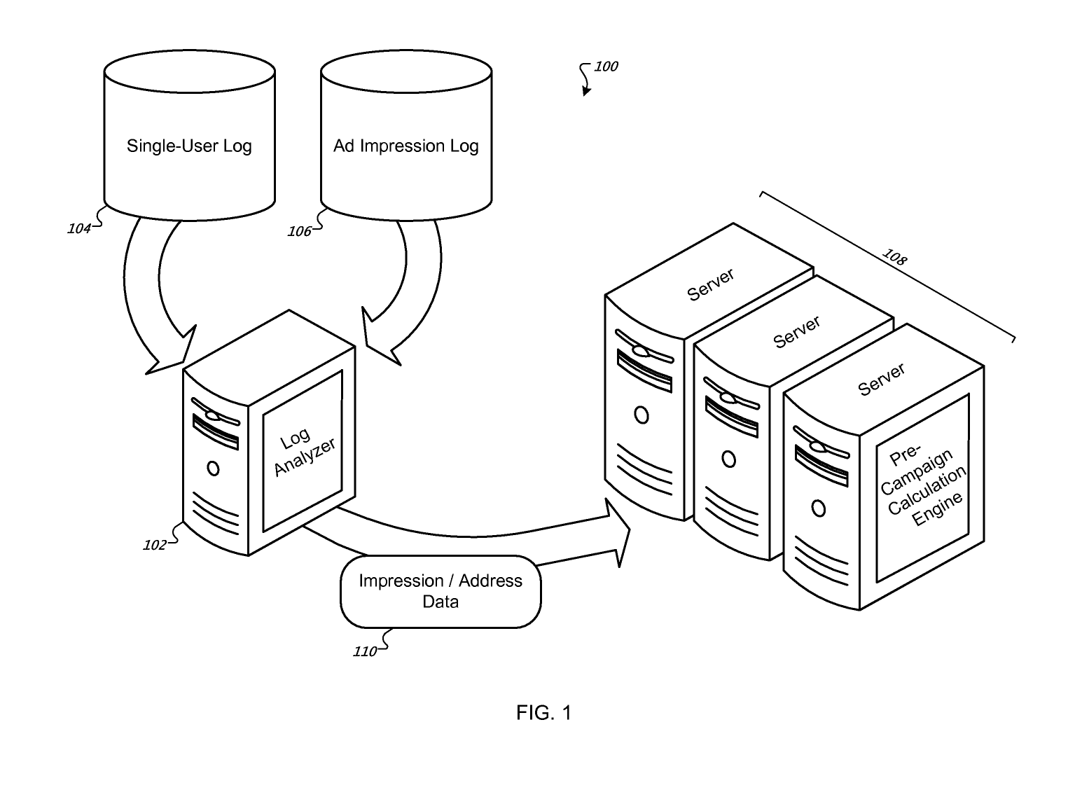

FIG. 1 schematically shows an exemplary system 100 for generating information to provide estimations for the performance of a user input advertising campaign. The system 100 includes a log analyzer 102, a single-user log 104, an ad impression log 106, and one or more pre-campaign calculation engines 108.

In the implementation of FIG. 1, the pre-campaign calculation engines 108 are hosted on servers, however, other devices can host the pre-campaign calculation engines 108. For example, all or part of the pre-campaign calculation engines 108 can be hosted on client systems or on systems that are isolated from a network connection, such as an Internet connection.

The ad impression log 106 contains information about advertisement impressions. In some implementations, an ad impression occurs when a user views an online ad. Ad impression information can include information, such as a language in which the ad is displayed, whether the ad is a text ad or whether it includes other media (e.g. images), and one or more countries to which the ad is directed.

In some implementations, the single-user log 104 contains addresses (e.g., Internet Protocol (IP) addresses) that are used by a single user, as opposed to an address shared by multiple users (e.g., multiple users may be represented by a single IP address when a group of users accesses the Internet through a proxy server). The single-user data in the single-user log 104 can be used to estimate a number of unique users for an ad campaign, which is described in detail below. By way of example, reference is made herein to addresses in general or specifically to IP addresses when referring to addresses associated with communications over networks that conform to the Internet Protocol. Other address types, as well as other network protocols, are possible.

The log analyzer 102 can process the ad impression log 106 and single-user log 104 to generate a set of data referred to as impression/address data (or impression/IP data) 110, which may be used by the system 100 to calculate estimates of advertising campaign metrics.

Processing the logs can include matching addresses (e.g., IP addresses) in the single-user log 104 to addresses in the ad impression log 106. In certain implementations, the log analyzer 102 processes the logs on a periodic basis, for example weekly. In other implementations, the log analyzer 102 processes the logs on a real-time basis.

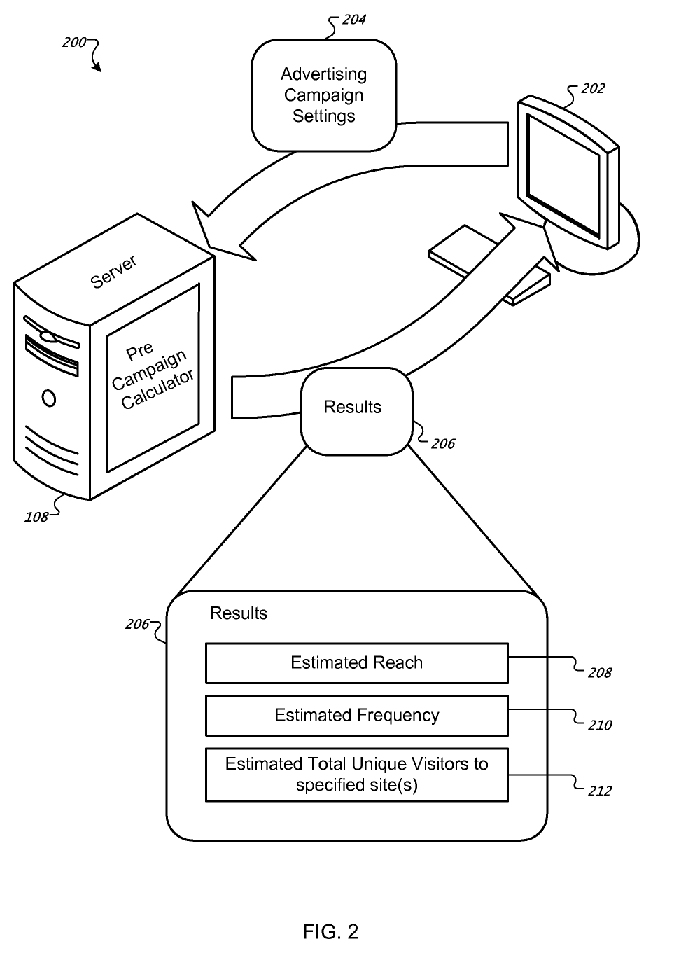

FIG. 2 is a schematic of a run-time query system 200 used to generate pre-campaign estimates, such as an anticipated number of people reached by an online campaign, for a user. The system 200 includes the pre-campaign calculation engine 108 and a client computer 202 associated with a potential advertiser. The potential advertiser supplies advertising campaign settings 204, or restrictions, such as a list of sites on which to run the campaign, a format of the ad, and geographic information (e.g., country domain identifiers, such as “.de” for Germany) to associate with display of the ads. Additionally, the campaign settings 204 can include information, such as a bidding price for showing the ads, a position in which to display the ads (e.g., across the top or at the upper right side of a web page), and a format in which to display the ads (e.g., text-only, text with an image, a size of the ad, etc.). Though a client server architecture is shown, other architectures are possible.

The pre-campaign calculation engine 108 calculates results 206 for campaign performance estimates, which can be displayed on the client computer 202. The results 206 can include estimates for reach 208, frequency 210, and total unique visitors 212 for websites specified by the ad campaign.

The reach 208 of an ad campaign is the number of unique users reached by a campaign over some period of time, such as per week, per month, or per year. For example, a particular ad campaign may be displayed to 500,000 users in a particular week.

The frequency 210 of an ad campaign is the average number of impressions a user sees over some period of time. For example, an ad campaign may have a frequency of twenty impressions per week per user.

“Unique visitors” 212 refers to the total number of unique users of a site or group of sites during a period of time regardless (or independent) of any particular ad campaign. The total number of unique visitors 212 can be a subset of the composite of visitors for a group of sites because the same visitor may visit multiple sites within the group. For example, coolsite.com may have 100,000 visitors in a week, and superneatsite.com may have 75,000 visitors in the week. However, when the users for these two sites are aggregated, the total number of unique visitors 212 to both sites may be only 125,000 because some visitors, in this case 50,000, have viewed both sites.

The pre-campaign calculation engine 108 can provide results 206 for campaign performance estimates to the user, e.g., in real time. By providing near real time results, advertisers can experiment with different campaign settings until their campaign performance requirements are met. For example, certain advertisers might be concerned with brand awareness so they may iteratively modify campaign settings to maximize reach 208.

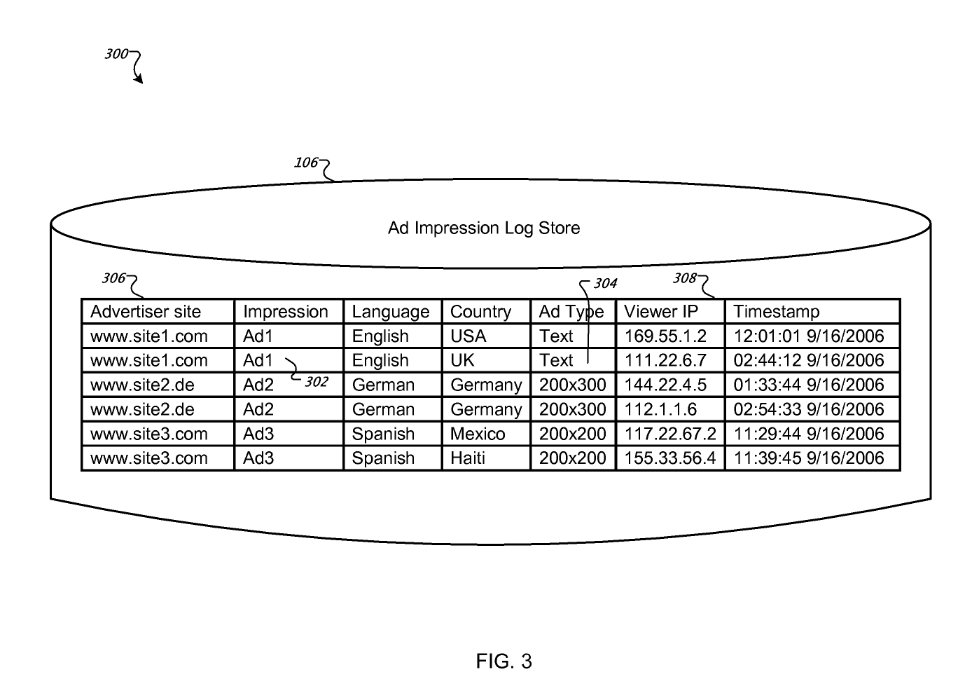

FIG. 3 is a detailed view 300 of an example advertisement impression log 106. In one implementation, an ad impression log 106 includes information, such as an identifier of an ad that was viewed, when the ad was viewed, the IP address of a user who viewed the ad, a site on which the ad was displayed, a language in which the ad was displayed, and a country associated with the site on which the ad was displayed. For example, the second line of the example log shows that an ad with an identifier “Ad1” 302 was viewed at 2:44 on Sep. 16, 2006, by a user who was using a computer associated with an IP address of 111.22.6.7, on a site www.site1.com, in English, in the United Kingdom.

The ad impression log 106 may also include an ad format type of the ad viewed. For example, the Ad1 ad from the second row of the example log is a text ad, as indicated by the term “Text” 304 in the Ad Type column of the table. In other examples, ads may include other media formats, such as image, audio, or video. Additionally, the media formats can include subcategories. For example, an image media format can include several display resolution categories, such as 200×300 pixels or 200×200 pixels.

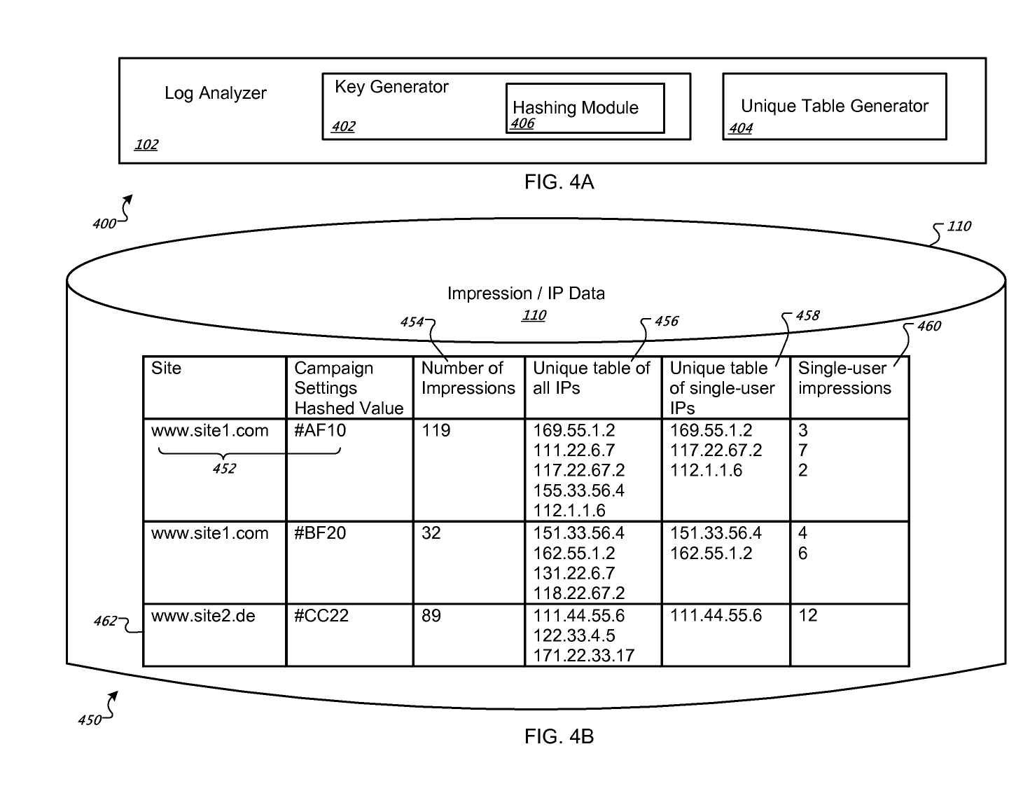

FIG. 4A is an example block diagram 400 of the log analyzer 102. In one implementation, the log analyzer 102 includes a key generator 402 and a unique table generator 404. The impression/address data that the log analyzer 102 generates can be grouped, for example, by site and by campaign setting information. In one implementation, in order to retrieve impression information, the impression data is indexed by a key, which includes a site name and a unique campaign setting combination.

In the implementation shown, the key generator 402 includes a hashing module 406, which can produce a unique hashed value for every campaign setting combination. The key generator 402 uses the hashed values to generate a key for each record of the impression/address data. In certain implementations, the generated key includes the site name and the hashed value (shown as key 452 in FIG. 4B).

The calculations performed by the pre-campaign calculation engine 108 can include calculating a count of unique visitors for the group of sites that the campaign targets (e.g., websites that are entered by a potential advertiser).

In certain campaigns, IP addresses logged as visiting one website may also be logged as visiting another website included in the online advertising campaign. The log analyzer 102 can aggregate IP addresses in the impression/address data in a way that eliminates duplicate IP addresses. In certain implementations, the log analyzer 102 uses the unique table generator 404 to create groups of IP addresses that can be merged to eliminate duplicate IP addresses.

FIG. 4B is an example set 450 of impression/address data 110. In certain implementations, the impression/address data 110 is generated by the log analyzer 102 as described above. The impression/address 110 can be indexed based on keys, each of which can include a site and a hashed value generated based on a set of campaign settings. For example, the first row of example data in FIG. 4B includes a key 452, which includes a site name www.site1.com and a hashed value of #AF10, which is generated based on a combination of campaign settings, or restrictions.

The campaign restrictions can include limitations, such as requiring the ads to be displayed on internet domains associated with a particular country, requiring the ads to be displayed in a specified language, and displaying the ads in a specified media format.

The impression/address data 110 can include a total count of impressions 454 associated with each key. For example, the website www.site1.com with the specified campaign settings #AF10 is associated with a total of 119 impressions (e.g., an ad may have been displayed on www.site1.com for the designated campaign settings 119 times).

In certain implementations, two unique tables of IP addresses are created by the unique table generator and stored for each key. The first unique table 456 can include IP addresses for users that have viewed an advertisement associated with a particular campaign, regardless of whether the IP addresses are shared by more than one user. The second unique table 458 can include only IP addresses associated with a single user (i.e., single-user IPs) for users that have viewed the advertisement.

For each single-user IP, an impression count 460 can be stored, which indicates how many times the advertisement with the specified campaign settings was displayed to the user associated with the single-user IP.

As an example, a record 462 in FIG. 4B has a key that includes a site “www.site2.de” and a campaign setting represented by a hashed value of “#CC22.” The total number of impressions (e.g., the number of times the ad was displayed) was 89 for this site and these campaign settings during a specified time period (not shown). The IP addresses of users who viewed impressions are 111.44.55.6, 122.33.4.5, and 171.22.33.17. Of those IP addresses, one, 111.44.55.6, was a single-user IP address. The number of impressions for the user with address 111.44.55.6 was 12 (e.g., the ad was displayed to this user 12 times).

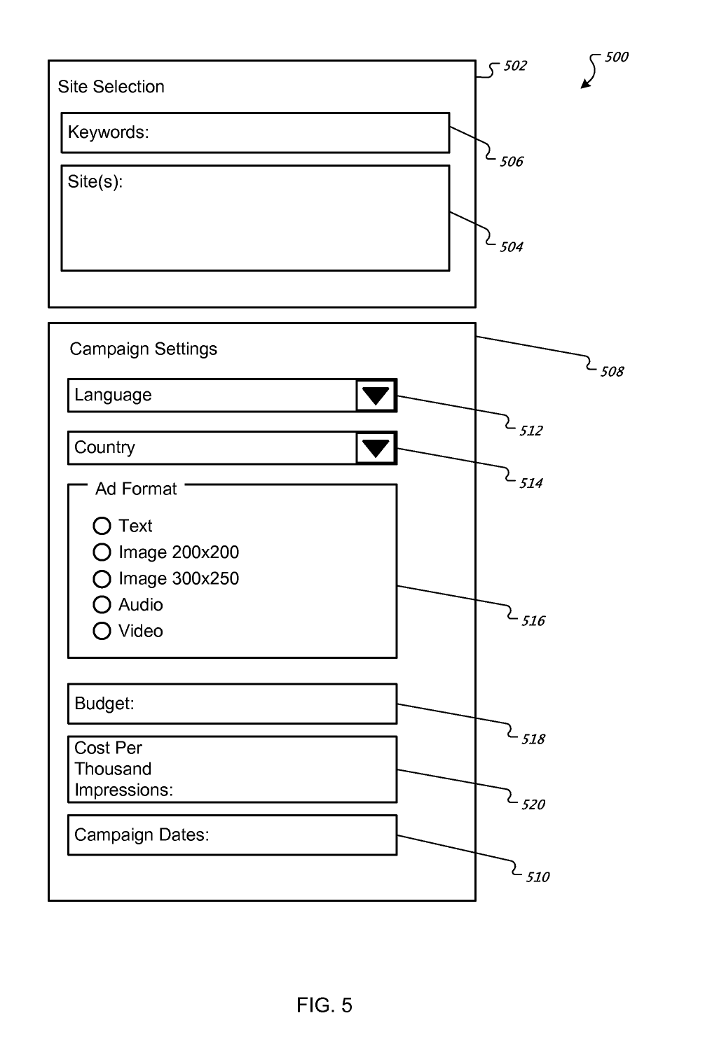

FIG. 5 is an example user interface 500 for a runtime query system 200 used to generate a pre-campaign estimate for a user. In the site selection area 502, an advertiser can specify websites in a website input area 504 for an ad campaign.

In some implementations, the advertiser can enter keywords, which are used to suggest websites for an ad campaign, in a keyword area 506. The potential advertiser can also enter sites directly using the website input area 504. For example, a potential advertiser can enter keywords, such as “software” or “spreadsheet” in the keyword area 506 or the potential advertiser could enter a site name such as www.microsoft.com directly in the website input area.

In some implementations, the system 200 can match the entered keywords 506 to a database which contains pairings of keywords and known sites that have content related to those keywords. This database can be part of a search engine system used to generate search results based on search queries.

In the campaign settings area 508, the advertiser can specify campaign dates 510 for the campaign, and the campaign dates 510 can be used to match historical dates from ad impression logs in order to calculate the pre-campaign performance estimates. For example, if the user enters campaign dates of Dec. 1, 2006 to Dec. 31, 2006, the system 200 can access historical data from the prior year, Dec. 1, 2005 to Dec. 31, 2005, and use the prior-year data when calculating the estimates for the specified campaign.

In certain implementations, the system can combine recent data (e.g., data from the previous month) with the historical data, which may increase the accuracy of the generated estimates. Expanding the previous example, if in November 2006, the user requests estimates for an ad campaign run in December 2006m the historical data from Dec. 1, 2005 to Dec. 31, 2005 can be supplemented with the data from October 2006 to determine the estimates.

The advertiser can use the campaign settings area 508 to select other parameters for the campaign. In certain implementations, the campaign can be restricted to a particular language using a language setting 512, or all languages may be selected. Similarly, the advertiser can specify a country for the campaign using a country setting 514 or all countries may be selected.

The advertiser can select an ad format 516 for the campaign. For example, ads may be text, image, audio, video, or a combination of media. The example interface allows a user to select from two defined image sizes, a 200×200 pixel image size and a 300×250 pixel image size.

In some implementations, the potential advertiser can further restrict the campaign by entering budget restrictions, which specify one or more spending thresholds for the campaign, such as bidding price for ad placement and total budget for the campaign. In certain implementations, advertisers can enter a total budget limit 518 or they can specify what they are willing to spend for ad placement, or ad ranking, on a webpage (e.g., a cost per thousand impressions 520). For example, an advertiser can specify they are willing to spend $20,000 for a campaign. In another example, the advertiser can specify that they are willing to spend $5 for one thousand impressions (which equates to a cost of one half cent per impression).

In other implementations, an advertiser can specify a maximum bid used in auctions to obtain advertisement ranking, or placement, on the specified website. An advertiser can experiment with budget settings to see how budgetary changes affect the advertising campaign, such as how the different budgetary restraints affect the campaign's reach.

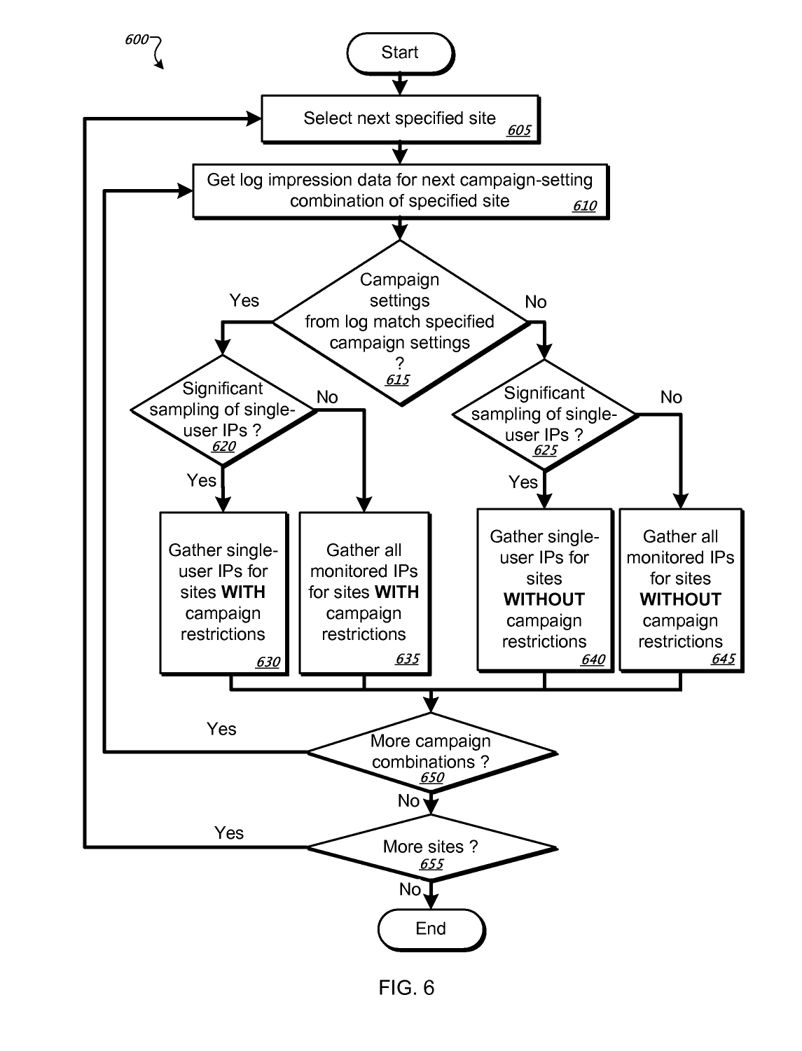

FIG. 6 is a flowchart of a method 600 for pre-campaign processing, according to one implementation. The method 600 can be performed, for example, by the pre-campaign calculation engine 108. The campaign estimates calculated for the user can include not just an estimate of reach for the advertiser-specified campaign restrictions, but also an estimate of the total number of unique visitors for the advertiser-specified sites, regardless of campaign restrictions. For example, a reach estimate for an advertiser's campaign may be 20,000 users reached in a week for a set of sites, while an estimate for the total number of users reached for those sites independent of any campaign restriction may be larger, such as 25,000.

A campaign can be specified by a user as a set of sites and a set of campaign restrictions. To calculate estimates for campaign performance, the user-specified sites and campaign restrictions can be matched to sites and campaign restriction combinations in the impression/address data, for example, by the pre-campaign calculation engine 108.

The impression/address data may include information related to the advertiser's specified sites and campaign restrictions. Additionally, the impression/address data may include other information related to the advertiser-specified sites, but for campaign restrictions not specified by the advertiser. The impression/address data that matches advertiser-specified campaign restrictions can be used to calculate campaign-specific estimates such as reach and frequency. The impression/address data that matches an advertiser-specified site but does not match advertiser-specified campaign restrictions can be used, for example, by the pre-campaign calculation engine 108, to calculate an estimate of total unique visitors to the specified sites.

In step 605, an advertiser-specified website can be selected and used to generate a key for use in looking up information for that site in the impression/address data. In certain implementations, the pre-campaign calculation engine 108 generates the key based on the advertiser-specified website.

In step 610, the next campaign restriction combination in the impression/address data related to the site selected in step 605 can be accessed, for example, by the pre-campaign calculation engine 108.

In step 615, it can be determined whether the campaign restrictions retrieved from the impression/address data in step 610 match the advertiser-specified campaign restrictions entered by a potential advertiser (e.g., a determination is made whether the key generated in step 605 from the user-specified campaign restrictions matches the key stored in the impression/IP data). In certain implementations, this determination is made by the pre-campaign calculation engine 108.

If the campaign restrictions from the log match the user-specified campaign restrictions, step 620 is performed. If the campaign restrictions from the log do not match the user-specified campaign restrictions, step 625 is performed. In certain implementations, steps 620 and 625 include substantially similar logic. For example, in each step, a test can be performed by the pre-campaign calculation engine 108 (or by the log analyzer 102) to determine whether the set of single-user addresses included in the impression/address data of step 610 is large enough to use a sampling approach to estimate frequency.

In certain implementations, a sampling approach can be used, where the approach estimates unique users by first estimating frequency, and then deriving an estimate of reach. Frequency can be estimated by using a sampling group of single-user addresses. The frequency can be calculated by dividing the number of impressions from single-user addresses by the number of single-user addresses. In certain implementations, this is performed by the pre-campaign calculation engine 108 in response to the site and campaign restrictions entered by a potential advertiser.

Not all site and campaign restriction combinations may have enough data to use a sampling technique, however. For example, the sample size may not result in a required confidence value or margin of error. For those site and campaign restriction combinations that do not have sufficient data for sampling, the number of unique users can be determined by deriving the number of unique users represented by a single-user address based on previous empirical research. For example, an estimate of unique users can be obtained by multiplying the number of IP addresses by two if previous research indicates two users are typically represented by one IP address. In certain implementations, the estimate can be generated by the log analyzer 102. In other implementations, the estimate can be generated by the pre-campaign calculation engine 108.

If, at step 620, there is a significant sampling of single-user addresses, step 630 is performed. At step 630, single-user addresses for sites associated with the advertiser-specified campaign restrictions can be gathered and the number of single-user addresses can be used in a frequency calculation by, for example, the pre-campaign calculation engine 108 to determine how many times an ad is displayed to a single user. Once all of the single-user addresses are gathered, the single-user addresses can be merged in order to remove duplicates, as described in more detail below.

Next, step 635 is performed if at step 620 there is an insufficient sampling of single-user addresses. In some implementations, a default algorithm for estimating unique users is executed (e.g., by the log analyzer 102) if the sampling size of single-user addresses is too small. For example, the total number of IP addresses may be multiplied by a factor that reflects an empirically determined number of users associated with a single IP address. For example, the total number of IP addresses can be multiplied by a factor of two (2) to determine an estimate of unique users. In certain implementations, the factor may be “2”. The log analyzer 102 can gather all monitored addresses for sites with campaign restrictions before performing the multiplication.

If there is a significant sampling of single-user addresses as determined in step 625, then step 640 is performed. Similar to the step 630, single-user addresses can be identified at step 640. However, the single-user addresses as identified in step 640 are associated with each site specified by a potential advertiser, regardless of other campaign restrictions entered by the potential advertiser. For example, the pre-campaign calculation engine 108 can use the single-user addresses from this larger set to calculate frequency and reach estimates that are independent of campaign restrictions specified by a potential advertiser.

If there is not a sufficient sampling of single-user addresses as determined step 625, step 645 is performed. Similar to the step 635, a default algorithm can be used (e.g., by the log analyzer 102) to estimate the number of users represented by a single user address.

Next at step 650, it can be determined whether there are any more campaign restriction combinations for the selected site. For example, one campaign restriction combination can include a website associated with text ads, and another campaign restriction can include the website associated with image ads. If there are more campaign restriction combinations, the method 600 can be iterated starting at the step 610. If there are no more campaign restriction combinations for the selected site, the process continues at step 655.

In step 655, it can be determined whether there are more advertiser-specified sites to include in the campaign. For example, a potential advertiser may specify several sites to include in the online advertising campaign. At the step 655, it can be determined if some of the specified sites remain unprocessed by the method 600. If there are more sites specified, the system 100, for example, iterates using method 600 starting at the step 605. If there are no more sites specified, the method ends.

The method of 600 can be implemented on a variety of devices. In certain implementations, it can be implemented using the log analyzer 102, the pre-campaign calculation engine 108, or a combination thereof (as described above).

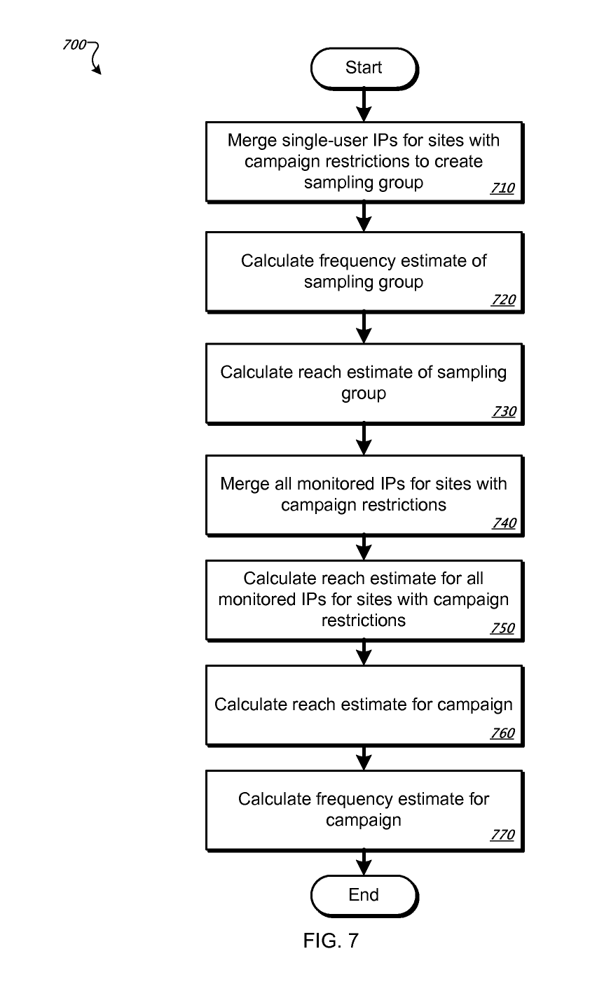

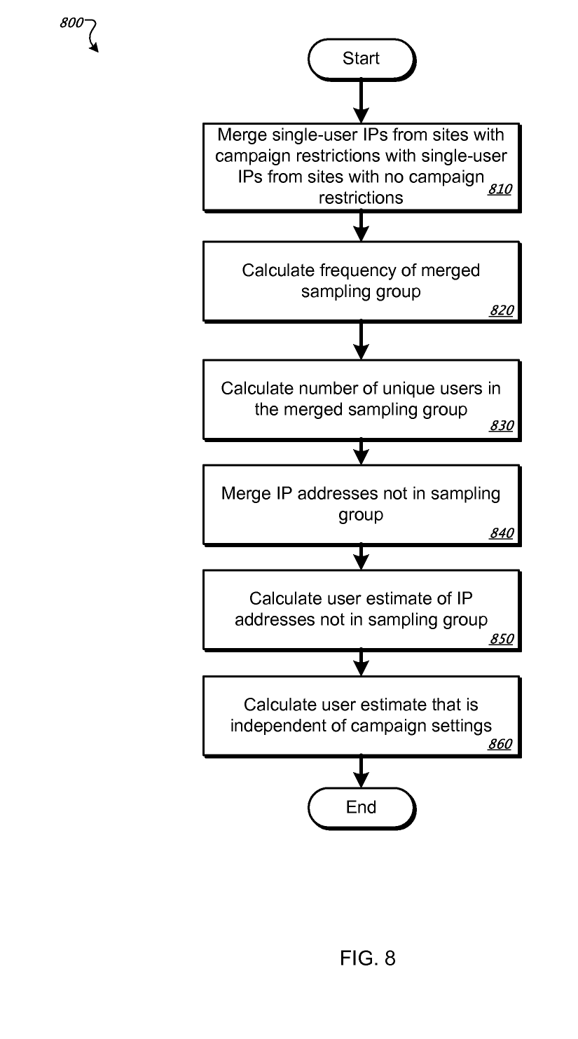

Additional methods, specified in FIGS. 7-8, can continue the processing of the four groups of impression/address data that have been gathered by the method 600 at the steps 630, 635, 640, and 645.

In summary, the following groups of impression/address data can be generated by the method 600: (1) a group of single-user addresses for sites with campaign restrictions (see the step 630); (2) a group of all-monitored addresses for sites with campaign restrictions, regardless of whether the addresses are associated with one or multiple users (see the step 635); (3) a group of single-user addresses for sites with no campaign restrictions (see the step 640); and (4) logged addresses for sites with no campaign restrictions (see the step 645).

FIG. 7 is a flowchart of an example method 700 for estimating reach and frequency of an ad campaign. The method 700 can be performed after the method 600 of FIG. 6 to generate estimates for reach and frequency for the user-specified campaign. More specifically, a sampling group of single-user (e.g. IP) addresses can be used to estimate frequency and reach of an ad campaign. For example, frequency can be calculated for a sampling group including single-user IP addresses by dividing the number of impressions displayed to IP addresses associated with a single user by the number of single-user IP addresses. This calculation can be expressed using the equation below, where “f” is a frequency estimate, “su_imp” is the number of impressions seen by single-user IP addresses, and “su_ip” is the number of single-user IP addresses:

f=su_imp/su_ip.

In step 710, an estimate of the count of unique single-user addresses for sites with campaign restrictions is obtained. In certain implementations, the total number of unique single-user IP addresses cannot be obtained by summing the number of single-user IP addresses for each individual site because there may be overlap between groups of single-user IP addresses from different site and campaign restriction combinations. For example, there may be 2,000 unique IP addresses for one site, and 3,000 IP addresses for another site, however, there may be only 4,500 unique IP addresses in total if there are 500 IP addresses that are common to both sites.

Several approaches can be used to merge sets of addresses (e.g. IP addresses) for purposes of obtaining an estimate of unique addresses. In certain implementations, a data structure is used (e.g., a table, hereinafter referred to as a unique table).

Use of the unique table can include 1) converting addresses into particular hash keys; 2) storing a certain number of hash keys with the smallest values 3) estimating the size of the entire set of addresses using an algorithm that computes how much space of possible hash keys is covered by the smallest hash keys.

Another approach that can be used for address merging includes using sorted single-linked lists and set union operations. A set union algorithm, such as the one available in the C++ Standard Template Library (STL), can be used to merge two lists to produce a new list containing only one instance of each unique element.

A third approach for merging addresses includes using bit vectors. Because IP addresses are bounded integers (0 to 2⁽³²⁻¹⁾), a set of IP addresses can be stored as a constant size bit vector. In certain implementations, the bit vector occupies approximately 2²⁹ bytes (512 megabytes) of memory. The bit vector approach may result in fast insertions and lookups. Additionally, counting the number of elements in the bit vector can be done in linear time.

A fourth approach for merging addresses includes using the bitset class provided in the STL C++ library, where the bitset class includes operations for setting and clearing bit flags. In certain implementations, step 710 is performed by the pre-campaign calculation engine 108.

In step 720, a frequency estimate is calculated for single-user addresses associated with the campaign restrictions (e.g., by the pre-campaign calculation engine 108). Frequency can be calculated as the sum of single-user impressions divided by the number of single-user addresses as described above. For example, if the sum of single-user impressions is 200,000 and the number of single-user addresses is 40,000, the frequency can be estimated to be 5 impressions per user.

In step 730, an estimate of reach for sites associated with the campaign restrictions is calculated (e.g., by the pre-campaign calculation engine 108). In certain implementations, the reach estimate is calculated by dividing the total number of impressions by the frequency estimate calculated in step 720, as shown in the equation below, where “r” is reach, “total_imp” is the total number of impressions for the sites and “f” is the frequency estimate obtained in step 720:

r=total_imp/f

For example, if the total number of impressions is 400,000 and the frequency estimate is 5 as in the example above from step 720, the number of unique users can be estimated as 80,000.

In step 740, all monitored addresses (which include both single-user and multiple-user addresses) for sites associated with the campaign restrictions for site and campaign restriction combinations that did not have enough single-user addresses to form a sufficient sample are merged into a set of unique addresses to eliminate duplicates (e.g., by the pre-campaign calculation engine 108), as discussed above.

In step 750, an estimate for reach is calculated for impression/address data for site and campaign restriction combinations that did not have enough single-user addresses to take part in the sampling estimation (e.g., by the pre-campaign calculation engine 108). An example approach that can be used to estimate reach is to assume that there are an average number of users behind an IP address based on historical averages and studies. For example, it can be determined than an estimate for the number of users associated with an IP address is 2.

In step 760, an estimate for the reach of the campaign is calculated (e.g., by the pre-campaign calculation engine 108). The reach of an ad campaign is the number of unique users reached by a campaign over some period of time, such as per week, per month, or per year. In certain implementations, the reach estimate for the campaign can be calculated by adding the reach estimates from step 730 and 750.

In step 770, an estimate for the frequency of the campaign is calculated (e.g., by the pre-campaign calculation engine 108). In certain implementations, the frequency can be calculated by dividing the total number of impressions for the campaign divided by the total number of unique users for the campaign which was determined in step 760.

FIG. 8 is a flowchart of a method 800 for estimating total unique visitors to websites specified by the potential advertiser, independent of any campaign restrictions, according to one implementation. This estimate can be obtained by merging groups of addresses and performing calculations similar to those done to obtain campaign-related estimates and can be performed by the pre-campaign calculation engine 108.

In step 810, single-user addresses for sites with campaign restrictions are merged with single-user addresses for sites with no campaign restrictions to form a set of unique addresses, using a merging technique such as those described above and executed, for example, by the pre-campaign calculation engine 108.

In step 820, a frequency estimate is calculated (e.g., by the pre-campaign calculation engine 108) for a sampling group of single-user addresses by, for example, dividing the total number of impressions displayed to the single-user addresses by the total number of single-user addresses.

In step 830, an estimate of the total number of unique users for the merged sampling group is obtained by, for example, by the pre-campaign calculation engine 108 dividing the total number of impressions from single-user addresses of the sampling group by the frequency value calculated in step 820.

In step 840, addresses gathered in steps 635 and 645 of method 600 are merged (e.g., by the pre-campaign calculation engine 108). These addresses are for sites and campaign restriction combinations that did not have enough single-user addresses to take part in the single-user frequency estimation.

In step 850, a unique user estimate is obtained for the merged address group from step 840 (e.g., by the pre-campaign calculation engine 108). In certain implementations, the pre-campaign calculation engine 108 determines an estimate of unique users by multiplying the number of addresses by a multiplier that is based on previous empirical research.

In step 860, the estimate of the total unique user count of all advertiser-specified sites is calculated. This estimate can be obtained by adding together the unique user counts from steps 830 and 850 (e.g., by the pre-campaign calculation engine 108).

The estimated frequency, reach, and the total number of visitors to the advertiser specified sites regardless of campaign restrictions can be included in results (e.g., results 206) that are displayed to the potential advertiser on the client computer 202. In certain implementations, a server hosting the pre-campaign calculation engine 108 can output the results to the client computer 202.

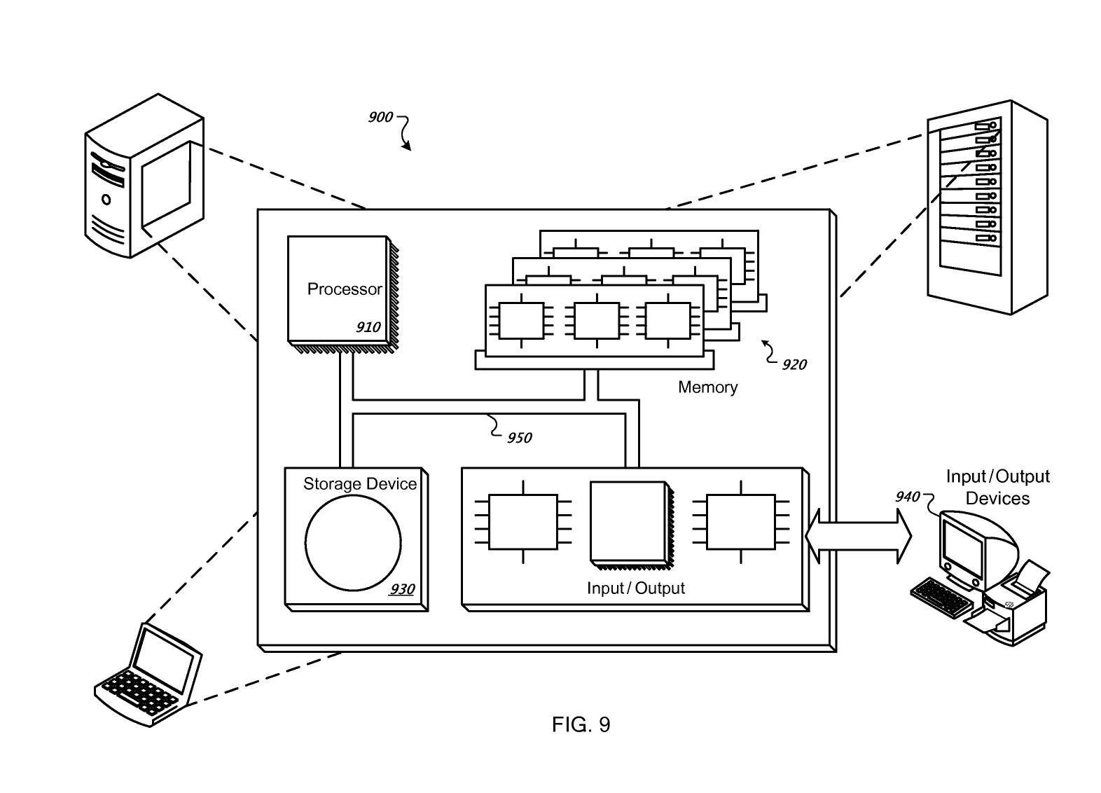

FIG. 9 is a schematic diagram of a computer system 900. The system 900 can be used for the operations described in association with any of the methods described previously, according to one implementation. Though a computing system is shown, the proposed methods can be implemented in other electronic devices. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the pre-campaign calculation engine 108 can derive campaign restrictions, such as media type and language, using an advertisement uploaded by a potential advertiser. The derived information can supplement or replace the intake of some of the information input into the user interface 500.

For example, the uploaded ad may include English text and an image. The pre-campaign calculation engine 108 can compare the text to several language corpuses to determine the appropriate language to target. The pre-campaign calculation engine 108 can also determine if the ad includes an image (or other media) by searching for a file associated with the ad that has an image extension (e.g., .jpg, .gif, .png, etc.). The determined language and presence of the image can be included in the campaign restrictions used to generate the pre-campaign estimate of reach, frequency, etc.

In other implementations, the estimates generated by the system 100 can be cached, for example, by the pre-campaign calculation engine 108 for use in subsequent estimates requested by other potential advertisers. For example, a first potential advertiser may specify that a proposed automobile advertising campaign includes two popular automotive websites, www.cars.com and www.edmunds.com. The system can generate an estimate of a total possible reach of these two websites, as described above, and this estimate may be cached on the pre-campaign calculation engines 108 before display to the first potential advertiser.

A second potential advertiser may also be interested in running an automobile advertising campaign, and also may specify that his or her campaign includes websites www.cars.com and www.edmunds.com because of the popularity of these websites. Instead of recalculating the estimate for total possible reach associated with the websites, the pre-campaign calculation engine 108 can access the previously stored value for display to the second potential advertiser.

In certain implementations, the system 100 can use previously cached estimates to derive a new estimate. For example, a third potential advertiser can specify an automobile advertising campaign that includes sites other than www.cars.com and www.edmunds.com. To calculate a total reach for the third automobile advertising campaign, the server may calculate the reach for the additional sites and add it to the previously cached reach estimate for the two websites.

In yet other implementations, the system 100 can cache information used to derive estimates calculated for proposed online advertising campaigns. For example, a group of single-user address associated with www.cars.com can be cached for use in subsequent estimates for campaigns that include the www.cars.com website.

In yet other implementations, the number of unique visitors associated with an IP address can be calculated using cookies associated with each visitor. The cookies may be generated by a cookie generator component of the system 100 (not shown) and transmitted to a user when the user visits a website associated with the system 100 (e.g., a search engine website).

If a different user represented by the same IP address visits the website associated with the system 100, the cookie generator component can transmit another cookie to the different user. In this way, the system 100 can estimate how many users are represented by a particular IP address based on the number of cookies assigned to users represented by the single IP address.

In yet other implementations, alternative methods can be used to compute the number of unique elements (e.g., IP addresses) in a set. The alternative methods include keeping and using every single element to get an exact count of elements.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining a first number of advertisement impressions per digital document visitor for a portion of a set of digital document visitors using log data; and
outputting, in response to a potential advertiser inputting one or more parameters associated with a proposed online advertising campaign, an estimate of a second number of digital document visitors reached by the proposed online advertising campaign associated with the one or more parameters.

2. The method of claim 1, wherein the log data comprises internet protocol (IP) addresses associated with the portion of the set of digital document visitors and advertisement impression data that indicates advertisements that were displayed to the portion of the set of digital document visitors.

3. The method of claim 2, wherein the one or more parameters associated with the proposed online advertising campaign specify a subset of the advertisement impression data for use in determining the first number.

4. The method of claim 3, further comprising outputting an estimate of a fourth number of digital document visitors reached by a proposed online advertising campaign specified by combinations of the one or more parameters and one or more digital documents associated with the proposed online s advertising campaign.

5. The method of claim 3, wherein the one or more parameters are selected from a group consisting of a specified language, an advertisement format, a geographical location associated with the advertisement, a time period, and a cost-per-impression.

6. The method of claim 1, further comprising deriving an estimate of a third number of advertisement impressions per digital document visitor for the set of digital document visitors using the first number.

7. The method of claim 1, wherein the proposed online advertising campaign comprises one or more digital documents at which to display advertisements.

8. The method of claim 7, further comprising generating the second number of the digital document visitors reached by the proposed online advertising campaign including dividing a total number of advertisement impressions associated with the one or more digital documents by the first number of advertisement impressions per digital document visitor for the one or more digital documents.

9. The method of claim 1, wherein the estimate is substantially calculated and output in real-time.

10. The method of claim 1, wherein the portion of the set of digital document visitors comprises single-user IP addresses that are each associated with a single digital document visitor.

11. The method of claim 10, wherein determining the first number of advertisement impressions per digital document visitor comprises deriving a representative value of advertisement impressions per single-user IP based on how many times an advertisement is transmitted to each single-user IP address.

12. The method of claim 1, further comprising outputting a frequency value that indicates a function of a number of times an advertisement of the proposed online advertising campaign is displayed to a digital document visitor.

13. The method of claim 12, wherein the function of the number of times the advertisement is displayed comprises an average number of times the advertisement is displayed.

14. The method of claim 13, further comprising generating the frequency value including dividing a total number of advertisement impressions by the second number of the digital document visitors reached by the proposed online advertising campaign.

15. The method of claim 1, further comprising generating the one or more parameters based on an advertisement submitted by the potential advertiser.

16. The method of claim 1, further comprising caching at least a portion of the output of the estimate for use in subsequent estimates requested by other potential advertisers.

17. The method of claim 1, further comprising iteratively outputting additional estimates in response to modifications of the one or more parameters for the proposed online advertising campaign.

18. A computer-implemented method comprising:
accessing historical information comprising a number of impressions associated with an advertisement displayed on one or more digital documents;
estimating a number of unique visitors to each digital document that displays the at least one advertisement; and
outputting, based on received advertising campaign parameters comprising identifiers specifying the one or more digital documents, at least one of a campaign reach value comprising an aggregate of the unique visitors for the specified one or more digital documents and a campaign frequency value comprising an average number of impressions displayed to a unique visitor.

19. The method of claim 18, wherein estimating the number of unique visitors to each digital document comprises multiplying a number of unique internet protocol (IP) addresses associated with clients that visit the digital document by a constant to obtain the estimate.

20. The method of claim 19, wherein the constant is two.

21. The method of claim 19, wherein the number of unique IP addresses associated with clients that visit the digital document is derived from the historical information.

22. The method of claim 18, wherein estimating the number of unique visitors to each digital document comprises generating an estimate of unique visitors represented by each unique IP address that visits the digital document and aggregating the estimates to determine an average used for the estimate.

23. The method of claim 22, wherein generating the estimate of unique visitors for each digital document comprises using a correspondence between the IP address and one or more client identifiers associated with the IP address.

24. The method of claim 23, wherein the client identifiers are selected from a group consisting of cookies, media access control addresses, and hardware configurations.

25. The method of claim 18, wherein the advertising campaign parameters further comprise a specified language, an advertisement format, a geographical location associated with the advertisement, a time period, or a cost-per-impression.

26. The method of claim 25, further comprising using a combination of the advertisement parameters to identify a category of advertisements associated with the specified digital documents.

27. The method of claim 25, further comprising outputting a total number of unique visitors for the digital documents specified by the identifiers regardless of other campaign parameters.

28. A system for estimating statistics associated with a proposed online advertising campaign comprising:
a log analyzer for generating data specifying a number of advertisements displayed for combinations of digital documents and advertising campaign restrictions;
an interface for receiving digital document and campaign restriction combination information from a potential advertiser; and
a pre-campaign calculation engine for outputting an estimate of a number of unique visitors reached by an proposed online advertising campaign at least partially defined by the received digital document and campaign restriction combination information.

29. A system comprising:
means for receiving campaign parameters for a proposed online advertising campaign that includes one or more digital documents;
means for determining a number of advertising impressions per digital document visitor for the one or more digital documents; and
means for outputting, in response to the received campaign parameters, an estimate of a number of unique visitors reached by the proposed online advertising campaign.
